(19) United States
(12) Patent Application Publication
(10) Pub. No.: US 2025/0305493 A1
(43) Pub. Date: Oct. 2, 2025

(54) GAS COMPRESSION SYSTEM AND METHOD FOR RECOVERING HYDROGEN

(71) Applicant: BURCKHARDT COMPRESSION AG, Winterthur (CH)

(72) Inventors: Adrian Luzi VALÄR, Winterthur (CH); Thorsten HARDER, Winterthur (CH)

(73) Assignee: BURCKHARDT COMPRESSION AG, Winterthur (CH)

(21) Appl. No.: 18/866,443

(22) PCT Filed: May 10, 2023
(86) PCT No.: PCT/EP2023/062447

§ 371 Date: Nov. 15, 2024

(30) Foreign Application Priority Data
May 18, 2022 (EP) 22174128.3

(51) Int. Cl. F04B 41/00; C01B 3/00; F17C 5/06

(52) U.S. Cl. CPC F04B 41/00; C01B 3/0036; C01B 3/0068; F17C 5/06; F17C 2221/012; F17C 2227/0164

(57) ABSTRACT

Gas compression system having a compressor for compressing hydrogen, a recovery device(s) for recovering hydrogen escaping as leakage gas during compression, and a leakage gas return line to return recovered leakage gas into a stage in the gas compression system upstream of the compressor and/or into a suction line of a compressor stage of the compressor. The compressor has a leakage gas discharge line for discharging leakage gas. Each recovery device is fluidically connectable to the discharge and return lines and has a metal hydride reservoir(s) heat-coupled to a respective heat exchanger. Each hydride reservoir has a hydride-forming metal alloy(s) which, when heat is supplied or dissipated through the respective heat exchanger, provides cyclic de- or absorption of leakage gas. Each recovery device increases leakage gas pressure in the discharge line to at least the pressure in the upstream stage and/or the suction pressure in the suction line.

The present invention relates to a gas compression system, a method for recovering hydrogen which is produced as leakage gas in a compressor, and a hydrogen filling station comprising a gas compression system as described below.

Hydrogen filling stations are used to refuel fuel cell vehicles with hydrogen fuel. Hydrogen filling stations known from the state of the art are constructed in such a way that the hydrogen is taken from a reservoir containing the hydrogen, pressurized in a compressor and fed into the hydrogen vehicle. The compression of hydrogen is technically challenging due to the low molar weight (also known as the molar mass or molar quantity-related mass) of hydrogen, especially with larger volume flows. For hydrogen gas to be filled into a fuel cell vehicle, a high level of purity and a high pressure, in particular of more than 400 bar, is now required.

EP 3 121 446 A1 describes an oil-lubricated piston compressor for compressing hydrogen and a refueling system for delivering hydrogen at high pressure to a fuel cell-powered vehicle. However, a disadvantage of using such an oil-lubricated piston compressor is that the oil content in the emitted hydrogen gas must be reduced as much as possible before it is delivered to a consumer in order not to impair the functioning of the fuel cell or even to avoid damaging it. For this purpose, appropriately designed separators and/or filters are used, for example, which are arranged downstream of the last compression stage. The requirement for separators and/or filters to separate lubricant from the compressed hydrogen leads to increased maintenance costs for such gas compression systems and ultimately to higher operating costs.

Piston compressors known from the prior art can often not be built pressure-encapsulated, which means that a certain leakage of the medium to be compressed into the environment must be accepted. For example, JP 2011-132876 A discloses a piston compressor for compressing hydrogen, in which the leakage of hydrogen from the compressor into the environment is accepted. Due to the flammability and the ability to form explosive mixtures, such a system—in addition to the waste of valuable resources and the associated economic disadvantages—also poses a considerable safety risk, depending on where the compressor is used.

To prevent leakage loss, WO 2015/074740 A1 proposes a leakage return line that runs from the interior of the piston compressor housing to the inlet on the first cylinder head of the compressor. The housing of the reciprocating compressor is therefore designed to be pressure-resistant at least up to the suction pressure of the first compressor stage. However, the disadvantage of a pressure-resistant solution is that the design effort and investment costs are comparatively higher than is the case with non-pressure-resistant compressor housings. In addition, the problem of the uncontrolled release of hydrogen into the environment is not satisfactorily solved by such a system, as the static seals used in it only allow leakage-free sealing of the excess hydrogen pressure in the housing to a limited extent.

Finally, a gas compression system for hydrogen is known from EP 3 163 081 A1, in which the hydrogen leakage from a main compressor is fed to an auxiliary compressor, whereby both compressors are reciprocating compressors. The hydrogen compressed by the auxiliary compressor is fed to a recovery tank and from there back to the suction line of the main compressor. However, due to the use of several reciprocating compressors with a large number of moving parts and a potentially high maintenance effort, as well as the pressure fluctuations resulting from the oscillating mode of operation of reciprocating piston machines and requiring the use of auxiliary tanks as pulsation dampers, this prior art gas compression system also has certain disadvantages.

Based on the aforementioned prior art, the present invention is based on the problem of eliminating such and other disadvantages of the prior art and, in particular, of providing a gas compression system for compressing hydrogen which is reliable, requires little maintenance and can be operated at low cost, including the cost of electricity consumption.

The problem is solved by a gas compression system for compressing hydrogen, a method for recovering hydrogen, and a hydrogen filling station comprising a gas compression system according to the invention as claimed in the independent claims. Advantageous embodiments and further embodiments are the subject of the dependent claims.

The problem is solved in particular with a gas compression system comprising a compressor for compressing hydrogen. The compressor has a leakage gas discharge line for discharging the hydrogen, which is produced as leakage gas during compression, from the compressor. The gas compression system also has at least one recovery device for recovering the hydrogen that is produced as leakage gas during compression, as well as a leakage gas return line. The leakage gas return line is designed to return the leakage gas recovered by the at least one recovery device to a point in the gas compression system upstream of the compressor. Alternatively or additionally, the leakage gas return line is designed to return the leakage gas recovered by the at least one recovery device to the suction line of a compressor stage of the compressor. Each recovery device can be fluidically connected to the leakage gas discharge line and the leakage gas return line and each has at least one metal hydride reservoir. Each metal hydride storage unit is heat-coupled to a heat exchanger and has at least one hydride-forming metal alloy, which is designed to cyclically de- or absorb the leakage gas by supplying or removing heat through the respective heat exchanger. The recovery devices present in the gas compression system are designed to increase the leakage gas pressure (p_{L}) prevailing in the leakage gas discharge line to at least the pressure (p) prevailing at the point of the gas compression system and/or to at least the suction pressure (p_{S}) prevailing in the suction line of the compressor stage.

The use of metal hydrides is a promising method of hydrogen compression that requires no moving parts and very little energy. In this method, a reversible heat-driven interaction of a hydride-forming metal, an alloy or an intermetallic compound with hydrogen gas is used to form a metal hydride. The exothermic formation of the metal hydride is favored by absorption of low-pressure hydrogen in the hydride-forming material at a low temperature, i.e. with heat removal from the hydride-forming material. On the other hand, the endothermic decomposition of the metal hydride is favored by desorption of high-pressure hydrogen from the metal hydride at a higher temperature, i.e. with the addition of heat to the metal hydride. In this way, periodic low-pressure hydrogen absorption or high-pressure hydrogen desorption can be achieved by periodically cooling and heating the hydride-forming material or the metal hydride, similar to the suction and pressure processes in a mechanical compressor. A device based on this principle is therefore also referred to below as a metal hydride compressor.

In the context of the present invention, a “compressor for compressing hydrogen” (hereinafter referred to simply as “compressor”) is understood to mean a device for increasing the pressure and density of the hydrogen serving as the working gas of the compressor, for example a reciprocating compressor, an ionic compressor, a screw compressor or a diaphragm compressor, but with the proviso that the compressor is not a metal hydride compressor. According to the invention, the at least one recovery device for increasing the leakage gas pressure to the suction pressure is a single-stage or multi-stage metal hydride compressor.

The gas compression system according to the invention has a simple configuration, is reliable, requires little maintenance and enables periodically operated hydrogen recovery with low operating costs. In addition, the use of metal hydride accumulators makes it possible to achieve high compression ratios with low power consumption and a high purity of the recovered hydrogen.

In particular, the compressor of the gas compression system according to the invention can also be a multi-stage compressor with a plurality of compressor stages, which are configured for stepwise compression of the working gas.

Preferably, the leakage gas return line is designed to return the leakage gas recovered by the at least one recovery device to the suction line of a first compressor stage of the compressor.

As a result, the pressure of the leakage gas only has to be increased to the relatively low pressure prevailing in the suction line of the first compressor stage, for example to a pressure of around 30 bar.

In a preferred embodiment, the gas compression system according to the invention comprises a first recovery device and a second recovery device, which are connected in parallel so that the metal hydride reservoirs arranged in the respective recovery devices can be loaded and unloaded independently of one another.

The provision of several recovery devices connected in parallel makes it possible to use the gas compression system according to the invention in a continuous process or for the continuous recovery of continuously occurring leakage gas.

Another problem that arises from operating a metal hydride compressor in a wider temperature range is the high thermal stresses that occur in the metal hydride reservoirs at the start of the heating and cooling half-cycles. If the additional stresses caused by the increase in gas pressure during hydride desorption (heating) and the increase in the volume of the hydride-forming metal alloys during hydride formation (cooling) are taken into account, the probability of damage to the metal hydride accumulators, for example due to cracking, increases, which significantly reduces the service life and safety of operation.

In order to keep the operating temperature range of each metal hydride storage unit as low as possible during operation, in a further preferred embodiment of the gas compression system, each recovery device has a plurality of metal hydride storage units.

Seen in the direction of flow of the leaked gas stream, the metal hydride reservoirs are connected in series with one another and are each heat-coupled with a heat exchanger. The series-connected metal hydride reservoirs each have at least one hydride-forming metal alloy, which is designed for the cyclic de- or absorption of hydrogen with the addition or removal of heat by the respective heat exchanger. The first metal hydride reservoir arranged first in the direction of flow in each recovery device is designed to increase the pressure of the leakage gas from the leakage gas pressure (p_{L}) to a first intermediate pressure (p₁) that is higher than the leakage gas pressure (p_{L}). The last metal hydride reservoir arranged last in the direction of flow in each recovery device is designed to increase the pressure of the leakage gas to the suction pressure (p_{S}). The metal hydride reservoirs arranged between the first and last metal hydride reservoirs are each designed to gradually increase the pressure of the leakage gas to a higher intermediate pressure (p₂, p₃ . . . pₙ) compared to the first intermediate pressure (p₁).

Unless otherwise stated, the term “flow direction” always refers to the flow direction of the leakage gas flow in the gas compression system according to the invention.

Preferably, the metal hydride accumulators connected in series each have a different hydride-forming metal alloy. This allows a higher compression ratio to be achieved.

In a particularly preferred embodiment of the gas compression system according to the invention, the metal hydride reservoirs connected in series contain hydride-forming metal alloys that are different from one another, wherein the thermal stability of the hydrated metal alloys decreases in the direction of flow, i.e. compared to the previously arranged metal hydride reservoir.

However, an increase in the number of metal hydride reservoirs in the recovery devices, or an increase in the number of stages of the metal hydride compressor thus formed, leads to a reduction in efficiency, which is why each recovery device preferably only has two metal hydride reservoirs.

In a preferred embodiment of the gas compression system according to the invention, the compressor of the gas compression system is designed as a piston compressor, wherein the gas compression system according to the invention can also be transferred or retrofitted to widely used, existing compressors.

Preferably, the compressor of the gas compression system is designed as a dry-running piston compressor. Dry-running piston compressors are compressors that operate without external lubricants, such as lubricating oil, in the compression section. This significantly reduces the risk of contamination of the compressed hydrogen by lubricants.

In a preferred embodiment of the gas compression system according to the invention, the hydride-forming metal alloys of the metal hydride reservoirs have a dissociation pressure of at least 30 bar at a temperature of 60-100° C., preferably at least 35 bar, and particularly preferably at least 40 bar. The measurement of the dissociation pressure is known to the skilled person from the prior art, for example from the publication by T. Matsunaga et al. “TiCrVMo alloys with high dissociation pressure for high-pressure MH tank”, International Journal of Hydrogen Energy, Vol. 34 (2009), 1458-1462, to which reference is made here (see therein section 2, “Experimental”).

With regard to the alloy systems that can be used, there are numerous hydrogenatable metal alloys, each of which has very specific pressure-temperature characteristics and is therefore particularly suitable for certain applications, wherein the alloy composition has a significant influence on the position of the pressure plateaus at a defined application temperature. An overview of common metal hydrides and their properties can be found in B. Sakintuna et al. “Metal hydride materials for solid hydrogen storage: A review”, International Journal of Hydrogen Energy, Vol. 32 (2007), 1121-1140, to which reference is made herein.

In a preferred embodiment of the gas compression system according to the invention, the hydride-forming metal alloys are selected from the group comprising LaNi₅, ZrV₂, ZrMn₂, TiMn₂, FeTi, Zr₂Co and Ti₂Ni. Preferably, the hydride-forming metal alloys are selected from the group comprising LaNi₅, ZrV₂, ZrMn₂ and TiMn₂.

The above-mentioned metal alloys have the advantage that a large working pressure range, which is defined by the difference between the leakage gas pressure (p_{L}) and the suction pressure (p_{S}), can be set in terms of alloy technology, in particular by combining two or more of the above-mentioned metal alloys.

In a preferred embodiment of the gas compression system according to the invention, the compressor has a housing that is essentially only pressure-resistant up to 40 bar. Preferably, the housing of the compressor is only pressure-resistant up to 15 bar, and particularly preferably only up to 2 bar. Such a housing is particularly easy and inexpensive to manufacture.

In a preferred embodiment, the gas compression system according to the invention has no containers for storing the leakage gas downstream of the at least one recovery device and before the leakage gas is returned to the point in the gas compression system upstream of the compressor. In other words, the gas compression system downstream of the at least one recovery device and before the leakage gas is fed back into the point in the gas compression system upstream of the compressor and/or into the suction line of the compressor stage is free of containers for storing the leakage gas. Alternatively or additionally, it is also conceivable that the gas compression system between the compressor and the at least one recovery device is free of containers for storing the leakage gas. In the latter case, the gas compression system thus has no containers for storing the leakage gas-with the exception of the hydrogen source of the compressor.

It will be understood that the elements of the present invention containing the term “line”, i.e. the elements serving to fluidically connect the devices of the gas compression system, are not to be regarded as “containers” within the meaning of the present invention.

This means that the gas compression system can be designed to be more compact and space-saving with less equipment.

The supply and removal of heat to and from the metal hydride reservoirs through the respective heat exchangers is achieved by surrounding the metal hydride reservoirs with a heat transfer medium that is very well insulated from the outside. The heat released when the hydrogen gas is stored is transferred to the heat transfer medium and heats it as well as the metal hydride reservoir itself. The volume of the heat transfer medium is dimensioned in such a way that the heat released can be completely absorbed by the heat transfer medium when the metal hydride reservoir is fully charged. Alternatively or additionally, it is also conceivable that the heat transfer medium of the respective heat exchanger is periodically or continuously exchanged by a suitable conveying device, for example a pump. The temperature rise obtained when loading the metal hydride reservoirs with hydrogen depends on the loading pressure and the choice of hydride-forming metal alloy.

In a preferred embodiment of the gas compression system according to the invention, the respective heat exchangers contain a liquid with a boiling temperature at normal pressure of between 30° C. and 180° C. as the heat transfer medium. Preferably, the boiling temperature of the liquid used as the heat transfer medium is between 90° C. and 130° C. at normal pressure. Water, water-glycol mixtures or thermal oils have proven to be particularly suitable heat transfer media, as they are generally readily available and safe to handle.

For the general application of metal hydride reservoirs, a heating system is required, as described above, which heats the metal hydride reservoirs for discharging. Up to now, electrical energy or fossil fuels have usually been used to heat the metal hydride reservoirs.

In a preferred embodiment of the gas compression system according to the invention, a gas cooler that can be cooled with cooling water is connected downstream of the compressor to cool the hydrogen gas compressed by the compressor. The gas cooler and the heat exchangers of the respective recovery devices are connected to each other in such a way that the cooling water heated during the cooling of the gas cooler can be used at least partially to supply heat to the respective metal hydride storage units.

The use of cold cooling water or cooling water that has been heated by a gas cooler means that no or only very small amounts of heating energy need to be supplied from outside to operate the metal hydride reservoirs. This also eliminates the need for an electrical power connection for heating. The total energy required to increase the leakage gas pressure is almost zero, apart from the power consumption for control and regulation. The use of cold or heated cooling water for cooling or heating the metal hydride reservoirs instead of electrical energy not only increases the overall efficiency of the industrial process, but also indirectly contributes to a reduction in greenhouse gases and other harmful emissions that are a by-product of electricity generation in thermal power plants using fossil fuels.

In a preferred embodiment of the gas compression system according to the invention, the leakage gas discharge line has a pressure relief valve. Preferably, the pressure relief valve opens at a pressure of more than 2 bar.

The provision of a pressure relief valve in the leakage gas discharge line serves to increase operational safety, as hydrogen, which cannot be absorbed by a recovery device due to a closed valve, for example, cannot accumulate in the leakage gas discharge line beyond its load limit.

In a preferred embodiment of the gas compression system according to the invention, each metal hydride reservoir has at least one combination valve or a pair of valves consisting of an inlet valve upstream of the respective metal hydride reservoir in the direction of flow and an outlet valve downstream of the respective metal hydride reservoir in the direction of flow for charging and/or discharging the respective metal hydride reservoir with leakage gas.

The use of a combination valve for charging or discharging the respective metal hydride reservoir with leakage gas has the advantage that the number of components required can be reduced. The use of valve pairs consisting of inlet and outlet valves, which are arranged upstream and downstream of the respective metal hydride reservoir, has the advantage that the direction of flow of the leakage gas in the at least one recovery device can be maintained and the pressure increase within the recovery devices can be made more efficient, as will be explained in more detail below.

It is conceivable that, in the case of several metal hydride reservoirs connected in series in the direction of flow, the outlet valve of a metal hydride reservoir arranged first in the direction of flow is also the inlet valve of a metal hydride reservoir adjacent to this metal hydride reservoir and arranged downstream in the direction of flow. As a result, the total number of valves required can be significantly reduced and the design complexity of the gas compression system can be further reduced.

In a preferred embodiment of the gas compression system comprising combination valves and/or valve pairs as described above, the gas compression system also has a control device for controlling the combination valves or the inlet and outlet valves. If inlet and outlet valves are present, these are controlled by the control device in such a way that, in normal operation, at least one of the adjacent valves is closed for each valve pair adjacent in the direction of flow in order to exclude a continuous, fluid-conducting connection between the leakage gas discharge line and the leakage gas return line.

In a preferred embodiment of the gas compression system according to the invention, at least one non-return element closing against the direction of flow is arranged between the metal hydride reservoirs of the respective recovery device. In addition or alternatively, at least one non-return element closing against the direction of flow is arranged in the leakage gas discharge line. In addition or alternatively, at least one non-return element that closes against the direction of flow is arranged in the leakage gas return line.

By excluding a fluid-conducting connection between the leakage gas discharge line and the leakage gas return line by means of an actuation device and/or the arrangement of the described non-return devices, a flashback of leakage gas against the direction of flow due to pressure differences between the individual metal hydride reservoirs can be excluded, which significantly reduces the risk of overloading and damage to components.

A preferred embodiment of the gas compression system according to the invention further comprises a pre-purification device for pre-purifying the hydrogen leakage gas before it is fed to the metal hydride reservoirs. In such a pre-purification device, the impurities which can have a detrimental effect on the service life of the hydride-forming metal alloys are already filtered out, converted and/or absorbed. For this purpose, the pre-cleaning device contains a catching material (getter material), wherein in particular hydride-forming metals or alloys, in which hydride formation only begins well above the maximum pressure of the downstream recovery device. This means that no hydride formation takes place at the getter material during pre-purification. Instead, however, other components of the hydrogen leakage gas are chemisorbed by the getter material and can therefore no longer lead to contamination or even damage to the actual hydride-forming metal alloys of the metal hydride reservoirs. This ensures long-term and reliable operation of the metal hydride reservoirs of the recovery systems.

Preferably, the pre-cleaning device for pre-cleaning the hydrogen leakage gas is arranged in the leakage gas discharge line, upstream of any branches leading to the individual recovery devices, so that the gas compression system can comprise only a single pre-cleaning device. Since the getter material must be replaced with fresh material from time to time depending on the quality of the leakage gas and the required degree of purity of the leakage gas purified by the pre-purification device, the effort required for this can be reduced with a single pre-purification device to be maintained. Alternatively or additionally, however, it is also conceivable that a pre-cleaning device is assigned to each recovery device, which increases flexibility in the operation and maintenance of the gas compression system.

The problem is further solved with a method for recovering hydrogen which is produced as leakage gas in a compressor. The method according to the invention comprises introducing the leakage gas into a recovery device with at least one metal hydride reservoir with at least one hydride-forming metal alloy (step a); loading the metal hydride reservoir with absorption of the introduced leakage gas by the metal alloy to form a metal hydride (step b); removing the heat released during the formation of the metal hydride by a heat exchanger which is heat-coupled to the metal hydride reservoir (step c); heating the formed metal hydride to a predetermined temperature by the heat exchanger with desorption of at least part of the previously absorbed leakage gas (step d); discharging the metal hydride reservoir and discharging the desorbed leakage gas from the recovery device to a leakage gas return line and into a stage in the gas compression system upstream of the compressor and/or into the suction line of a compressor stage of the compressor from which the leakage gas originates (step e). Step e) can optionally be carried out with further heating of the metal hydride formed by the heat exchanger. The pressure of the leakage gas is increased in step d)—and if necessary also in step e) if the heating of the formed metal hydride is continued—by the at least one metal hydride reservoir of the recovery device from the leakage gas pressure (p_{L}) prevailing in the leakage gas discharge line to at least the pressure (p) prevailing at the point of the gas compression system and/or at least the suction pressure (p_{S}) prevailing in the suction line of the compressor stage. The pressure increase within the recovery device is achieved by appropriate control of inlet and outlet valves, which are arranged upstream and downstream of the metal hydride reservoir in the direction of flow, as will be described in more detail below.

Preferably, the method for recovering hydrogen according to the invention as described herein is carried out using a gas compression system according to the invention as described herein.

In a preferred embodiment of the method according to the invention, the pressure of the leakage gas is increased from the leakage gas pressure (p_{L}) to the suction pressure (p_{S}) in several stages using a plurality of metal hydride reservoirs connected in series with one another in the direction of flow in the recovery device. In this case, the first metal hydride accumulator arranged first in the direction of flow in the recovery device increases the pressure of the leakage gas from the leakage gas pressure (p_{L}) to a higher first intermediate pressure (p₁) compared to the leakage gas pressure (p_{L}). The last metal hydride reservoir arranged last in the direction of flow in the recovery device increases the pressure of the leakage gas to the suction pressure (p_{S}). If necessary, metal hydride reservoirs arranged between the first metal hydride reservoir and the last metal hydride reservoir increase the pressure of the leakage gas in stages to a higher intermediate pressure (p₂, p₃ . . . pₙ) compared to the first intermediate pressure (p₁).

In a preferred embodiment of the method according to the invention, the method is carried out continuously with cyclic loading and unloading of two recovery devices arranged in parallel in the direction of flow. Each recovery device comprises at least one metal hydride reservoir.

In a further preferred embodiment of the method according to the invention, the heating of the metal hydride formed in step d) is carried out at least partially with water, which is obtained from the cooling of a gas cooler downstream of the compressor.

In a preferred embodiment of the method according to the invention, each metal hydride reservoir is charged and discharged via at least one combination valve or a pair of valves consisting of an inlet valve upstream of the respective metal hydride reservoir in the direction of flow and an outlet valve downstream of the respective metal hydride reservoir in the direction of flow. In the latter case, the respective inlet and outlet valves are actuated by a control device in such a way that a continuous, fluid-conducting connection between the leakage gas discharge line and the leakage gas return line is excluded.

The advantages resulting from the implementation of the methods described herein essentially correspond to the advantages already described for the respective embodiments of the gas compression system according to the invention.

The problem is further solved by a hydrogen refueling station comprising a gas compression system as described herein, which is preferably operated by one of the methods described herein. Various embodiments of the invention are described below with reference to drawings, with identical or corresponding elements generally being provided with identical reference signs. It shows:

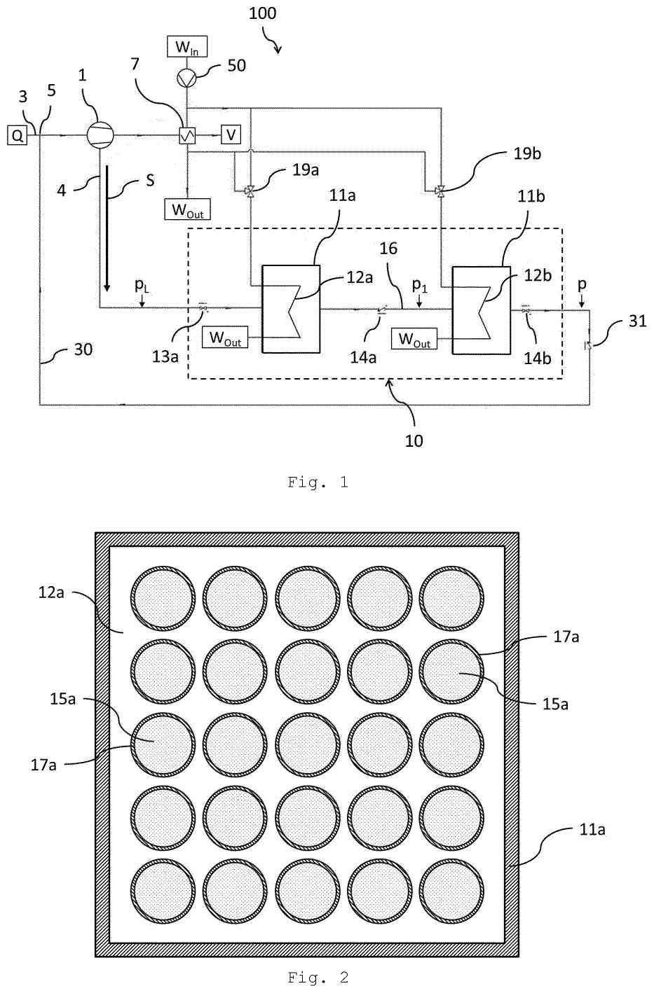

FIG. 1 Flow diagram showing a gas compression system according to the invention;

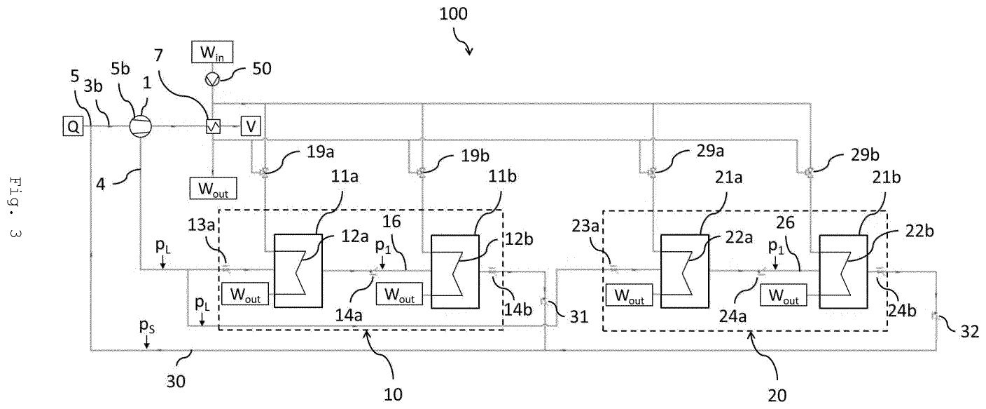

FIG. 2 Schematic representation of a metal hydride reservoir for use in a gas compression system according to the invention in cross-section;

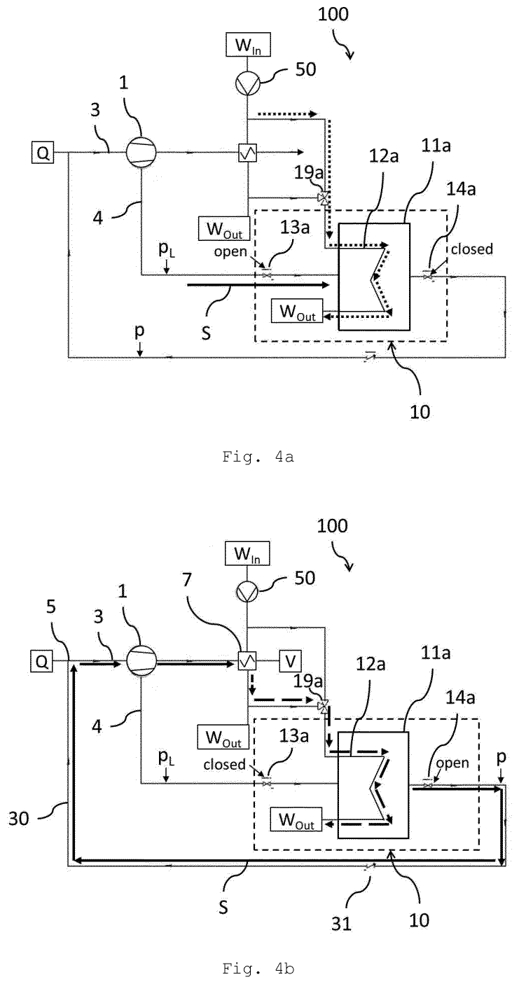

FIG. 3 Flow diagram showing a further embodiment of a gas compression system according to the invention with two recovery devices connected in parallel;

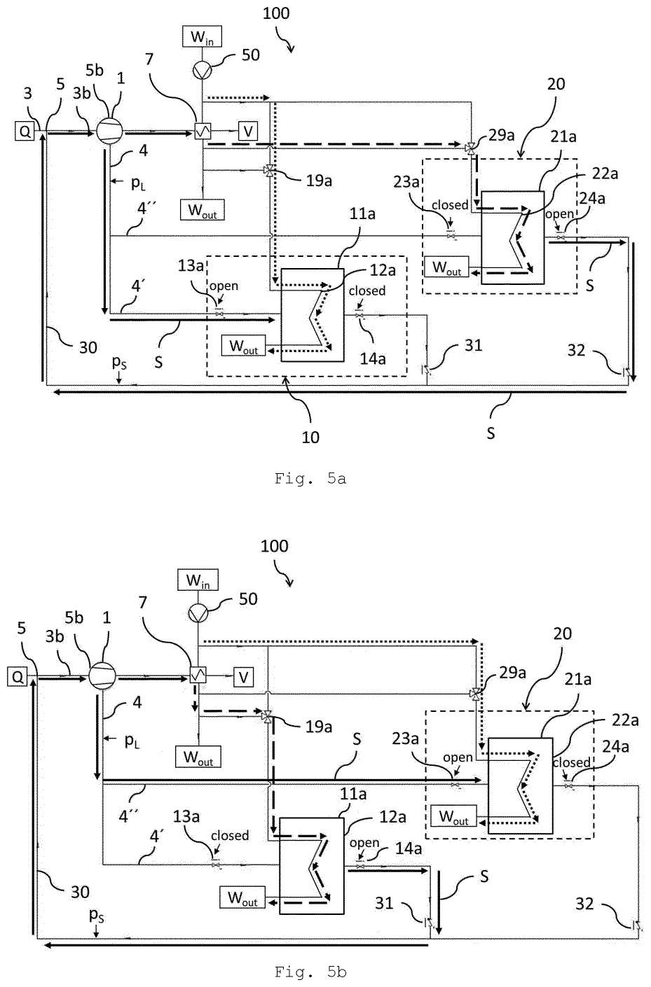

FIG. 4a Flow diagram showing a gas compression system according to the invention in a loading step;

FIG. 4b Flow diagram showing the gas compression system from FIG. 4a in an unloading step;

FIG. 5a Flow diagram showing a further embodiment of a gas compression system according to the invention with recovery devices connected in parallel in a loading or unloading step;

FIG. 5b Flow diagram showing the gas compression system from FIG. 5a in an unloading or loading step.

FIG. 1 shows a flow diagram of a gas compression system 100 according to the invention with a compressor 1 for hydrogen. The compressor 1 can be fluidically connected to a hydrogen source Q via a line 3, so that the hydrogen to be compressed can be fed to the compressor 1 via the line 3. The gas compression system 100 also comprises a recovery device 10, described in more detail below, for recovering hydrogen which escapes from the compressor 1 as leakage gas during compression. To discharge the leakage gas from the compressor, a leakage gas discharge line 4 is provided, which can be fluidically connected to the compressor and the leakage gas flow produced during compression. The gas compression system 100 also has a leakage gas return line 2 for returning the leakage gas recovered by the recovery device 10 to a stage 5 in the gas compression system 100, which is located upstream of the compressor 1 from which the leakage gas originates. In the embodiment shown in FIG. 1, the leakage gas recovered by the recovery device 10 is introduced into the line 3, which fluidically connects the hydrogen source Q to the compressor 1, at the stage marked with the reference sign 5. The leakage gas return line 30 has a non-return element 31 which closes against the direction of flow S. In the embodiment shown, the recovery device comprises two metal hydride reservoirs 11a, 11b, which each contain a hydride-forming metal alloy and are each heat-coupled to a heat exchanger 12a, 12b. Cold cooling water, which can be supplied to the gas compression system 100 from a cooling water source W_{In} via a cooling water pump 50, can be used to cool the two metal hydride reservoirs 11a, 11b. Preheated cooling water, i.e. cooling water which is obtained in the course of cooling the hydrogen compressed by the compressor 1 by a gas cooler 7, can be used to heat the two metal hydride reservoirs 11a, 11b. The cold or heated cooling water can be fed to the two metal hydride reservoirs 11a, 11b via three-way fittings 19a, 19b. Unused or spent cooling water is fed to cooling water drains W_{Out} and preferably recycled. The recovery device 10 can be fluidically connected to the leakage gas discharge line 4 via the inlet valve 13a of the first metal hydride reservoir 11a and to the leakage gas return line 2 via the outlet valve 14b of the second metal hydride reservoir 11b. The two metal hydride reservoirs 11a, 11b can be fluidically connected to each other via a connecting line 16 and a valve 14a arranged in the connecting line 16 and, viewed in the flow direction S of the leakage gas flow, are connected in series. The metal hydride reservoir 11a arranged first in the direction of flow S is designed to increase the leakage gas pressure p_{L}, which is for example 2 bar, in the leakage gas discharge line 4 to a higher first intermediate pressure p₁, which is for example 15 bar, compared to the leakage gas pressure p_{L}. The metal hydride reservoir 11b of the recovery device 10, which is arranged last in the direction of flow S, is designed to increase the first intermediate pressure p₁, which is provided by the metal hydride reservoir 11a upstream thereof, to the pressure p prevailing in line 3, which is 30 bar, for example. The leakage gas thus recovered, i.e. raised from the leakage gas pressure p_{L} to the pressure p, is fed back to the compressor 1 and ultimately delivered to a consumer V, for example a fuel cell vehicle.

FIG. 2 shows a schematic cross-sectional representation of a metal hydride reservoir 11a for use in a gas compression system according to the invention. In the embodiment shown, the metal hydride reservoir 11a comprises a total of twenty-five tubular containers 17a (shown in cross-section in FIG. 2), which are filled with a hydride-forming metal alloy 15a. The containers 17a are designed for the inlet and outlet of hydrogen leakage gas into the containers 17a, wherein in the case of tubular containers 17a the inlets and outlets are preferably arranged at the opposite ends of the tubes. The containers 17a containing the hydride-forming metal alloy 15a are surrounded by a heat transfer medium, in particular water or a thermal oil, so that the metal alloy 15a can desorb or adsorb leakage gas when heat is supplied or dissipated by the heat exchanger 12a. To improve the heat conduction between the heat transfer medium and the container wall, ribs made of material with good thermal conductivity can be arranged on the outer surface of the container 17a to increase the surface area, which are immersed in the heat transfer medium (not shown).

FIG. 3 shows a flow diagram of a further embodiment of a gas compression system 100 according to the invention, which comprises two recovery devices 10, 20 connected in parallel for recovering hydrogen which escapes from a compressor 1 as leakage gas. The first recovery device 10 comprises the two metal hydride reservoirs 11a and 11b connected in series, while the second recovery device 20 comprises the two metal hydride reservoirs 21a and 21b connected in series. The metal hydride reservoir 11a of the first recovery device 10, which is arranged first in the direction of flow S, can be fluidically connected to the metal hydride reservoir 11b arranged downstream in the direction of flow S via connecting line 16 and the valve 14a arranged therein. Similarly, the metal hydride reservoir 21a of the second recovery device 20, which is arranged first in the direction of flow S, can be fluidically connected to the metal hydride reservoir 21b arranged downstream in the direction of flow S via connecting line 26 and the valve 24a arranged therein. Hydrogen leakage gas, which is produced during compression by the compressor 1 of the gas compression system 100, is discharged from the compressor 1 through a leakage gas discharge line 4 and is connected to the first recovery device 10 or the second recovery device 20 via the inlet valve 13a or via the inlet valve 23a, which inlet valves 13a, 23a connect the first recovery device 10 or the second recovery device 20 to the inlet valve 23a. the second recovery device 20 with the leakage gas discharge line 4, alternating in time, i.e. the recovery devices 10, 20 arranged in parallel operate in push-pull mode. Within each recovery device 10, 20, the pressure of the leakage gas is increased from the leakage gas pressure p_{L} prevailing in the leakage gas discharge line via a first intermediate pressure p₁ to the suction pressure p_{S} prevailing in the suction line 3b of the first compressor stage 5b of compressor 1, essentially as described above with respect to FIG. 1. The metal hydride reservoirs 11a, 11b, 21a, 21b are each heat-coupled to a heat exchanger 12a, 12b, 22a, 22b for this purpose, wherein the water used to cool or heat the metal hydride reservoirs can be fed to the heat exchangers 12a, 12b, 22a, 22b from a cooling water source W_{In} with cooling water pump 50 or after prior heating by a gas cooler 7 via three-way fittings 19a, 19b, 29a, 29b. Unused or spent cooling water is fed to cooling water drains W_{Out} and preferably recycled. The first recovery device 10 and the second recovery device 20 can be fluidically connected to a leakage gas return line 2 via the outlet valves 14b and 24b of the metal hydride reservoirs 11b, 21b arranged last in the respective recovery devices 10, 20 in the direction of flow S, wherein a non-return element 31, 32 is arranged downstream of each recovery device 10, 20 in the direction of flow S. Via the leakage gas return line 30, the leakage gas previously recovered and increased to the suction pressure p_{S} is fed into the suction line 3b of the first compressor stage 5b of compressor 1 at the stage designated by the reference sign 5.

FIG. 4a shows a flow diagram of a gas compression system 100 according to the invention comprising a single recovery device 10 at the time of loading of the single metal hydride reservoir 11a contained therein. A portion of the hydrogen, which is supplied to the compressor 1 via a line 3 from a hydrogen source Q, is generated during compression as a leakage gas stream, which is discharged from the compressor via a leakage gas discharge line 4 and introduced into the metal hydride reservoir 11a of the recovery device 10 via the inlet valve 13a. To load the metal hydride reservoir 11a with leakage gas and form a metal hydride, the inlet valve 13a upstream of the metal hydride reservoir 11a in the flow direction S of the leakage gas is opened and the outlet valve 14a downstream of the metal hydride reservoir 11a in the flow direction S of the leakage gas flow is closed, as indicated in FIG. 4a. The heat released during the formation of the metal hydride is dissipated through a heat exchanger 12a, which is heat-coupled to the metal hydride reservoir 11a, wherein cold cooling water from a cooling water source W_{In} is used for this purpose via a cooling water pump 50 and a three-way fitting 19a, which fluidically connects the cooling water source to the heat exchanger 12a (see dotted arrows in FIG. 4a to illustrate the flow of cold water). The used cooling water, which was heated in the heat exchanger 12a during the cooling of the hydride-forming metal alloy, is fed to a cooling water drain Wₒᵤₜ. Once the metal hydride reservoir 11a has been charged with leaked gas, the inlet valve 13a upstream of the metal hydride reservoir 11a in the flow direction S is closed (not shown).

FIG. 4b shows a flow diagram of the gas compression system 100 from FIG. 4a during the unloading of the metal hydride reservoir 11a of the recovery device 10. The metal hydride reservoir 11a was previously heated to a predetermined temperature by the heat exchanger 12a for desorption of at least a portion of the previously absorbed leakage gas with the inlet and outlet valves 13a, 14a closed, wherein a pressure relief valve present in the leakage gas discharge line continuously discharges leakage gas from the compressor 1 when a predetermined leakage gas pressure is exceeded (not shown). After the pressure inside the metal hydride reservoir 11a has been increased to the pressure p prevailing in the line 3, the outlet valve 14a of the metal hydride reservoir 11 downstream in the flow direction S of the leakage gas is opened and the metal hydride reservoir 11a is unloaded by the heat exchanger 12a with further heat input. In the present embodiment example, water from the cooling water source W_{In} is used for this purpose, which was supplied to a gas cooler 7 by the cooling water pump 50 and heated by it (see dashed arrows in FIG. 4b to illustrate the flow of hot water). The three-way fitting 19a used, with which the heat exchanger 12a can be fluidically connected both to the cooling water source W_{In} and to the gas cooler 7, can also be used to mix cold cooling water from the cooling water source W_{In} and cooling water heated by the gas cooler 7 in order to adjust the temperature of the metal hydride reservoir 11a. The desorbed leakage gas under pressure p is discharged from the recovery device 10 via outlet valve 14a to a leakage gas return line 30, which comprises a non-return element 31 opening in the direction of flow S, and is introduced into line 3 at a stage marked with the reference sign 5. The recovered leakage gas is thus fed back to the compressor 1 and ultimately discharged to a consumer V.

FIG. 5a shows a flow diagram of a further embodiment of a gas compression system 100 according to the invention, comprising two recovery devices 10, 20 connected in parallel, each with a metal hydride reservoir 11a, 21a. In FIG. 5a, the first recovery device 10 is in a loading cycle and the second recovery device 20 operates in a counter-cycle to this in an unloading cycle. In other words, while the metal hydride reservoir 11a of the first recovery device 10 is being loaded, the metal hydride reservoir 21a of the second recovery device 20 is being unloaded. In contrast to the method described in FIGS. 4a and 4b, the recovery of leakage gas, which occurs during the compression of hydrogen in a compressor 1, can thus be carried out continuously with the method described in FIGS. 5a and 5b. For this reason, overpressure valves in the leakage gas discharge line 4, which open when a certain leakage gas pressure p_{L} prevailing therein is exceeded, can generally be dispensed with. For safety reasons, however, the provision of such pressure relief elements to prevent pressure peaks and damage in the leakage gas discharge line 4 may still be advisable. In the embodiment of a gas compression system 100 according to the invention shown in FIGS. 5a and 5b, the leakage gas discharge line 4 branches into the two leakage gas discharge lines 4′ and 4″, of which one leakage gas discharge line 4′ can be fluidically connected to the first recovery device 10 and the other leakage gas discharge line 4″ can be fluidically connected to the second recovery device 20. The loading of the metal hydride reservoir 11a of the first recovery device 10 takes place with the inlet valve 13a open and the outlet valve 14a closed, which are arranged upstream and downstream of the metal hydride reservoir 11a in the flow direction S of the leakage gas, and with heat dissipation from the hydride-forming metal alloy contained in the metal hydride reservoir by a heat exchanger 12a, which is heat-coupled to the metal hydride reservoir 11a. The cold cooling water used for this purpose is provided by a cooling water source W_{In} via a cooling water pump 50 and a three-way fitting 19a, which fluidically connects the cooling water source to the heat exchanger 12a (see dotted arrows in FIG. 5a to illustrate the flow of cold water). The used cooling water is discharged into a cooling water outlet Wₒᵤₜ. The metal hydride reservoir 21a of the second recovery device 20 is unloaded when the inlet valve 23a is closed and the outlet valve 24a is open and the metal hydride reservoir 21a is heated by the heat exchanger 22a assigned thereto. The heat exchanger 22a is fluidically connected to the cooling water source W_{In} via the three-way fitting 29a, wherein the heated cooling water is obtained by a gas cooler 7, which cools the hydrogen compressed by the compressor 1 before it is discharged to a consumer V (see dashed arrows in FIG. 5a to illustrate the flow of hot water). The cooling water used in the heat exchanger 22a of the second recovery device 20 is also discharged into a cooling water outlet W_{Out} and preferably recycled. The first recovery device 10 and the second recovery device 20 can be fluidically connected to a leakage gas return line 30 via the outlet valves 14a and 24a of the metal hydride reservoirs 11a, 21a arranged last in the respective recovery devices 10, 20 in the flow direction S, wherein a non-return element 31, 32 is arranged downstream of each recovery device 10, 20 in the flow direction S. The leakage gas, which has been compressed by the second recovery device 20 from the leakage gas pressure p_{L} to the suction pressure p_{S}, is fed into the first compressor stage 5b of the compressor 1 via the leakage gas return line 30 at the stage of the suction line 3b designated by the reference sign 5. The gas compression system, including the valves described above, is monitored and controlled by a freely programmable system control device not shown.

FIG. 5b shows a flow diagram of the gas compression system 100 from FIG. 5a, where the first recovery device 10 is now in the unloading cycle and the second recovery device 20 is in the loading cycle, merely to illustrate the counter-cycled operation of the two recovery devices 10 and 20 connected in parallel. The hot water flow in the gas compression system 100 is shown using dashed arrows and the cold water flow using dotted arrows. The assignment of the reference symbols used and the functional description of all the elements shown in FIG. 5b can be found in the description of FIG. 5a.

1. A gas compression system with
a compressor for compressing hydrogen;
at least one recovery device for recovering hydrogen which escapes from the compressor as leakage gas during compression; and
a leakage gas return line which is designed to return the leakage gas recovered by the at least one recovery device into a stage in the gas compression system upstream of the compressor, or into a suction line of a compressor stage, or into the stage in the gas compression system upstream of the compressor and into the suction line of the compressor stage;
wherein the compressor comprises a leakage gas discharge line for discharging the leakage gas from the compressor;
wherein each recovery device can be fluidically connected to the leakage gas discharge line and the leakage gas return line and has at least one metal hydride reservoir, each of which is heat-coupled to a heat exchanger;
wherein each metal hydride reservoir comprises at least one hydride-forming metal alloy which is designed for cyclic de- or absorption of the leakage gas with heat supply or removal through the respective heat exchanger; and
wherein each recovery device is designed to increase a leakage gas pressure (p_{L}) prevailing in the leakage gas discharge line to at least a pressure (p) prevailing in the stage of the gas compression system, or to at least a suction pressure (p_{S}) prevailing in the suction line of the compressor stage, or both.

2. The gas compression system according to claim 1, wherein the at least one recovery device comprises a first recovery device and a second recovery device for loading and unloading the metal hydride reservoirs arranged in the respective recovery devices independently of one another in terms of time.

3. The gas compression system according to claim 1, wherein each recovery device has a plurality of metal hydride reservoirs which are connected in series with one another as viewed in the flow direction of the leakage gas stream and are each heat-coupled to a heat exchanger;
wherein the metal hydride reservoirs connected in series each have at least one hydride-forming metal alloy, which are designed for the cyclic de- or absorption of hydrogen with heat supply or removal through the respective heat exchanger;
wherein the first metal hydride reservoir arranged first in the direction of flow in each recovery device is designed to increase the pressure of the leakage gas from the leakage gas pressure (p_{L}) to a first intermediate pressure (p₁) which is higher than the leakage gas pressure (p_{L});
wherein the last metal hydride reservoir arranged last in each recovery device in the direction of flow is designed to increase the pressure of the leakage gas to the suction pressure (p_{S}); and
wherein the metal hydride reservoirs arranged between the first and the last metal hydride reservoir are each designed to gradually increase the pressure of the leakage gas (2) to a higher intermediate pressure (p₂, p₃ . . . pₙ) relative to the first intermediate pressure (p₁).

4. The gas compression system according to claim 1, wherein the compressor is designed as a piston compressor.

5. The gas compression system according to claim 1, wherein the metal alloys used have a dissociation pressure of at least 30 bar at a temperature of 60-100° C.

6. The gas compression system according to claim 1, wherein the metal alloys are selected from the group consisting of LaNi₅, ZrV₂, ZrMn₂, TiMn₂, FeTi, Zr₂Co, and Ti₂Ni.

7. The gas compression system according to claim 1, wherein the compressor has a housing which is designed to be pressure-resistant only up to 40 bar.

8. The gas compression system according to claim 1, wherein the gas compression system is free of containers for storing the leakage gas downstream of the at least one recovery device and before the leakage gas is returned to the stage in the gas compression system upstream of the compressor, or into the suction line of the compressor stage, or to the stage in the gas compression system upstream of the compressor and into the suction line of the compressor stage.

9. The gas compression system according to claim 1, wherein the respective heat exchangers contain a liquid with a boiling temperature at normal pressure of between 30° C. and 180° C. as heat transfer medium.

10. The gas compression system according to claim 1, wherein a gas cooler which can be cooled with cooling water is connected downstream of the compressor for cooling the hydrogen compressed by the compressor, wherein the gas cooler and the heat exchangers of the respective recovery devices are connected to one another in such a way that a cooling water heated during the cooling of the gas cooler can be used at least partially to supply heat to the respective metal hydride reservoirs.

11. The gas compression system according to claim 1, wherein the leakage gas discharge line has a pressure relief valve which opens at a pressure of more than 2 bar in the leakage gas discharge line.

12. The gas compression system according to claim 1, wherein each metal hydride reservoir comprises at least one combination valve or a valve pair consisting of an inlet valve upstream of the respective metal hydride reservoir in the direction of flow, and an outlet valve downstream in the direction of flow of the respective metal hydride reservoir for charging or discharging the respective metal hydride reservoir with leakage gas.

13. The gas compression system according to claim 12, further comprising an actuating device for actuating the inlet and outlet valves, wherein the inlet and outlet valves are actuated in such a way such that, in operational use, at least one of the adjacent valves is closed for each pair of valves adjacent in the direction of flow, in order to exclude a continuous fluid-conducting connection between the leakage gas discharge line and the leakage gas return line.

14. The gas compression system according to claim 1, wherein at least one non-return element closing against the direction of flow is arranged at a position selected from the group consisting of between the metal hydride reservoirs of the respective recovery device, in the leakage gas discharge line, and in the leakage gas return line.

15. A method for recovering hydrogen which emerges from a compressor as a leakage gas, carried out with the gas compression system according to claim 1, the method comprising the steps of:
introducing the leakage gas into a recovery device with at least one metal hydride reservoir Ha containing at least one hydride-forming metal alloy;
loading of the metal hydride reservoir with absorption of the introduced leakage gas by the metal alloy and formation of a metal hydride;
removing of a heat released during the formation of the metal hydride by a heat exchanger, which is heat-coupled to the metal hydride reservoir;
heating of the formed metal hydride to a predetermined temperature by the heat exchanger with desorption of at least part of the previously absorbed leakage gas;
discharging the metal hydride reservoir and discharging the desorbed leakage gas from the recovery device to a leakage gas return line and into a stage in the gas compression system upstream of the compressor, or into a suction line of a compressor stage, or into the stage in the gas compression system upstream of the compressor and into the suction line of the compressor stage, of the compressor from which the leakage gas originates;
wherein the pressure of the leakage gas is increased by the at least one metal hydride reservoir of the recovery device from a leakage gas pressure (p_{L}) prevailing in the leakage gas discharge line to at least a pressure (p) prevailing in the stage of the gas compression system or at least a suction pressure (p_{S}) prevailing in the suction line of the compressor stage, or both.

16. The method according to claim 15,
wherein the pressure of the leakage gas is increased from the leakage gas pressure (p_{L}) to the suction pressure (p_{S}) in several stages using a plurality of metal hydride reservoirs connected in series with one another as viewed in the flow direction of the leakage gas flow;
wherein the first metal hydride reservoir arranged first in the direction of flow in each recovery device increases the pressure of the leakage gas from the leakage gas pressure (p_{L}) to a first intermediate pressure (p₁) which is higher than the leakage gas pressure (p_{L});
wherein the last metal hydride reservoir arranged last in the direction of flow in each recovery device increases the pressure of the leakage gas to the suction pressure (p_{S}); and
wherein the metal hydride reservoirs arranged between the first and the last metal hydride reservoir increase the pressure of the leakage gas in stages to a higher intermediate pressure (p₂, p₃ . . . pₙ) relative to the first intermediate pressure (p₁).

17. The method according to claim 15, wherein the method is carried out continuously with cyclic charging and discharging of two recovery devices arranged in parallel in the flow direction and each comprising at least one first metal hydride reservoir.

18. The method according to claim 15, wherein the heating of the formed metal hydride in step d is carried out at least partially with water obtained from a cooling of a gas cooler downstream of the compressor.

19. The method according to claim 15, wherein the charging and discharging of each metal hydride reservoir takes place via at least one combination valve or a valve pair consisting of an inlet valve upstream of the respective metal hydride reservoir in the direction of flow, and an outlet valve downstream of the respective metal hydride reservoir in the direction of flow, wherein the respective inlet and outlet valves are actuated by an actuating device in such a way that a continuous fluid-conducting connection between the leakage gas discharge line and the leakage gas return line is excluded.

20. A hydrogen refueling station comprising a gas compression system according to claim 1.
